(19) United States
(12) Patent Application Publication
(10) Pub. No.: US 2009/0060256 A1
(43) Pub. Date: Mar. 5, 2009

(54) METHOD OF ADVERTISEMENT SPACE MANAGEMENT FOR DIGITAL CINEMA SYSTEM

(76) Inventors: Timothy J. White, Webster, NY (US); Shoupu Chen, Rochester, NY (US); Nathan D. Cahill, Rochester, NY (US)

Correspondence Address: Frank Pincelli;Patent Legal Staff, Eastman Kodak Company, 343 State Street, Rochester, NY, 14650-2201, US

(21) Appl. No.: 11/846,607

(22) Filed: Aug. 29, 2007

(51) Int. Cl. G06K 9/00

(52) U.S. Cl. 382/100

(57) ABSTRACT

A method for automatically collecting viewer statistics from one or more persons in a movie theater, the method including the steps of capturing an image of the one or more persons in the movie theater with an infrared camera; using a face recognition algorithm to determine persons present in the movie theater; and determining one or more categories from characteristics from persons present to compute the viewer statistics.

### FIELD OF THE INVENTION

The present invention relates to a digital image processing method for automatic image content analysis. More specifically, the present invention relates to applying infrared cameras and a facial recognition algorithm to a movie theater for image content analysis.

### BACKGROUND OF THE INVENTION

Content Providers in the movie theater industry are responsible for selling ad space as part of pre-feature “entertainment” in the theater. Ad sponsors desire accurate feedback on the success or improvement opportunities of their ads. In this regard, facial recognition has been done for determining the number of viewers in the audience. For example, Publication WO2006060889A1 discloses using facial recognition for detecting the faces and gazes of the audience.

Even though the presently known and utilized method and system are satisfactory, they include drawbacks. Movie theaters are frequently displayed in low lighting conditions. This makes facial recognition difficult and inaccurate. Consequently, a need exists to overcome this drawback.

### SUMMARY OF THE INVENTION

The present invention is directed to overcoming one or more of the problems set forth above. Briefly summarized, according to one aspect of the present invention, the invention resides in a method for automatically collecting viewer statistics from one or more persons in a movie theater, the method including the steps of capturing an image of the one or more persons in the movie theater; using a facial-recognition algorithm to determine persons present in the movie theater; and determining one or more categories from characteristics from persons present to compute the viewer statistics.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of improving detection of an audience of a movie theater, particularly in low-lighting conditions of theaters.

### BRIEF DESCRIPTION OF THE DRAWINGS

FIG. 1 is a schematic diagram of an image processing system useful in practicing the present invention;

FIG. 2 is a flowchart illustrating an advertisement space management method of the present invention;

FIG. 3 is a flowchart of the present invention illustrating a scheme of capturing background images and a plurality of foreground plus background images in time sequence for face detection and demographic data gathering;

FIG. 4A is an illustration of a theater background scene of the present invention;

FIG. 4A′ is an illustration of a static background image of the present invention;

FIG. 4B is an illustration of a theater foreground plus background scene of the present invention;

FIG. 4B′ is an illustration of a foreground plus background image of the present invention;

FIG. 5 is a flowchart illustrating gathering viewer demographic data of the present invention;

FIG. 5′ is an illustration of a foreground image of the present invention;

FIG. 6 is an illustration of a foreground image divided into a plurality of cells of the present invention; and

FIG. 7 is a flowchart for identifying age and gender characteristics of the present invention.

### DETAILED DESCRIPTION OF THE INVENTION

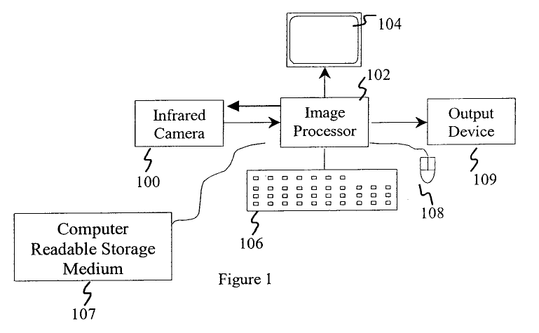

FIG. 1, shows an image processing system useful in practicing the present invention. The imaging system includes an image source 100, preferably a camera that captures an image with at least a non-visible portion of a spectrum (such as an infrared camera) or a multimodal imaging device that includes at least a non-visible portion of the spectrum (such as an infrared sensing system) and a color image sensing system, and a digital image or a composite digital image from the infrared camera or a multimodal imaging device 100 is provided to an image processor 102, such as a programmable personal computer, or digital image processing work station such as a Sun Sparc™ workstation. Composite digital image means an image containing content from both the visible spectrum and the non-visible portion of the spectrum. The infrared camera or a multimodal imaging device 100 can be controlled by the image processor 102. The image processor 102 may be connected to a CRT display 104, a user interface such as a keyboard 106 and/or a mouse 108. The image processor 102 is also connected to a computer-readable, storage medium 107. The image processor 102 transmits processed digital images to an output device 109. Output device 109 may include, for example, a hard copy printer, a long-term image storage device, a connection to another processor, or an image telecommunication device connected, for example, to the Internet, or a wireless device.

In describing the present invention, it should be apparent that the computer program of the present invention can be utilized by any well-known computer system, such as the personal computer of the type shown in FIG. 1. However, many other types of computer systems can be used to execute the computer program of the present invention. For example, the method of the present invention can be executed in the computer contained in a digital camera or a device combined or inclusive with a digital camera. Consequently, the computer system will not be discussed in further detail herein.

It is to be understood that the present invention may make use of image manipulation algorithms and processes that are well known. Accordingly, the present description will be directed in particular to those algorithms and processes forming part of, or cooperating more directly with, the method of the present invention. Thus, it will be understood that the computer program of the present invention may embody algorithms and processes not specifically shown or described herein that are useful for implementation. Such algorithms and processes are conventional and within the ordinary skill in such arts.

Other aspects of such algorithms and systems, and hardware and/or software for producing and otherwise processing the images involved or co-operating with the computer program product of the present invention, are not specifically shown or described herein and may be selected from such algorithms, systems, hardware, components, and elements known in the art.

The computer program for performing the method of the present invention may be stored in a computer readable storage medium. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the Internet or other communication medium. Those skilled in the art will readily recognize that the equivalent of such a computer program product may also be constructed in hardware.

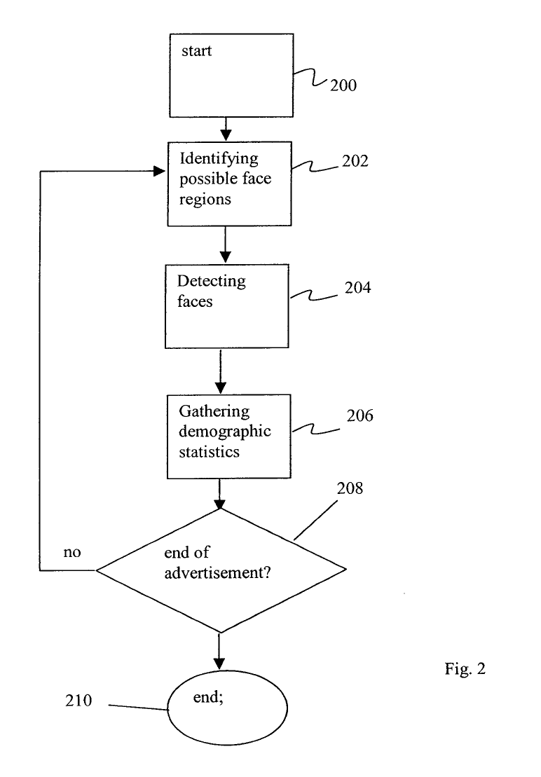

Now referring to FIG. 2, the acquiring of movie-viewer, demographic data of the present invention is illustrated. It is noted that, during the time of playing advertisements before a movie starts, the number of viewers typically varies. Consequently, multiple acquisitions of movie viewer demographic data preferably take place in a time-sequence fashion by the infrared camera 100.

After a start step 200, the first step in acquiring of movie viewer demographic data for advertisement space management is identifying possible face regions 202 which is followed by detecting faces 204 and demographic statistics gathering 206. There is a query step 208 that checks if it is the end of advertisement time. If not, the acquiring of movie viewer demographic data repeats; otherwise the program ends 210.

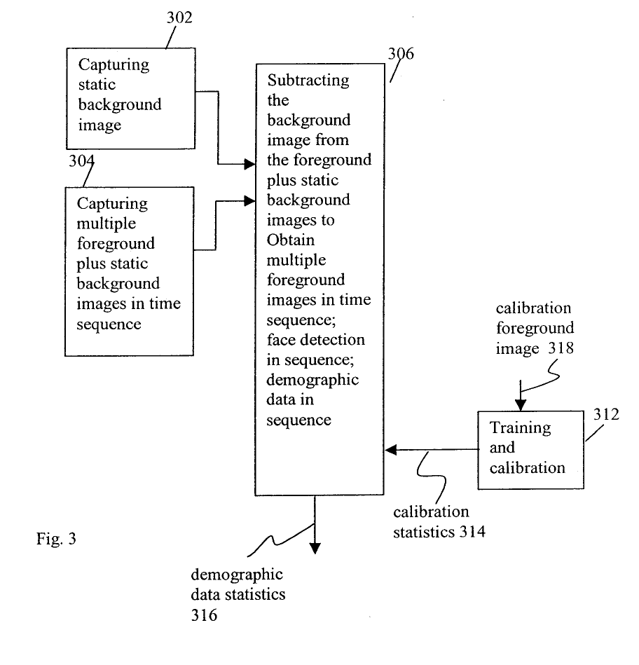

Referring to FIG. 3, an overview of details of acquiring movie viewer demographic data for advertisement space management of the present invention is shown. First, a user captures a static background image 302 and then captures multiple foreground plus static background images in time sequence 304. A program of the present invention subtracts the background from each foreground plus static background image 306 for obtaining an image of only the people. From this resulting people image, a face detection algorithm senses the faces for obtaining characteristics of the audience such as gender and age. This data is stored as demographic data statistics 316.

In order to determine characteristics, a training and calibration step 312 is done in order to obtain calibration statistics 316 which are used to train the algorithm to determine the characteristics obtained in step 306.

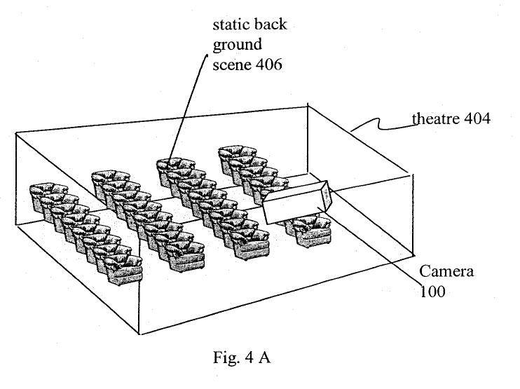

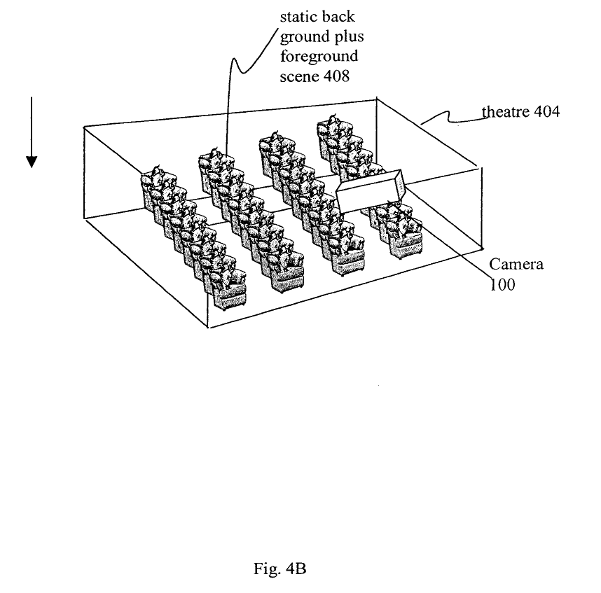

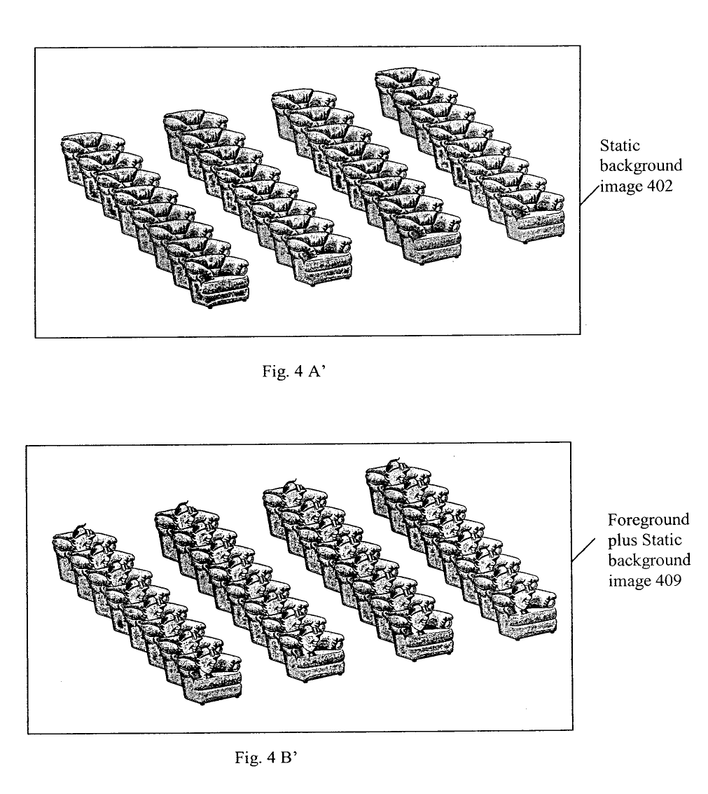

Referring to FIG. 4A, there is illustrated a preferred embodiment of step 302. In this regard, an infrared camera or a multimodal imaging device 100 takes one or more pictures (digital images or composite digital images) of the static background scene 406 in a theater 404. The resultant image is a static background image 402 as illustrated in FIG. 4A′. The theater background scene is time invariant in general over a period of time, for example, in one hour or in one day. Therefore, the static background image 402 can serve as a reference image. FIG. 4A shows a scene of theater 404 and its static background scene 406. The static background 406 includes any non-viewer or non-person objects (inanimate objects) such as seats and walls that are fixed relative to the infrared camera 100. In general, the seats and walls have unchanged shapes and positions in time. The static background image 402 of the static background scene 406 is denoted by I^{B}. The fixed infrared camera 100 could take a plurality of images of the static background scene 406. Therefore, the static background image 402 I^{B} could be a statistical average of the plurality of background images.

In FIG. 4B, there is illustrated the physical details regarding step 306 (as shown back in FIG. 3). In this regard, there is a scene of the theater static background plus a foreground 408. The theater foreground contains a plurality of movie viewers. During the time of playing advertisements before the movie starts, the number of movie viewers varies. This is the reason there is step 306 of capturing multiple foreground plus static background images in time sequence.

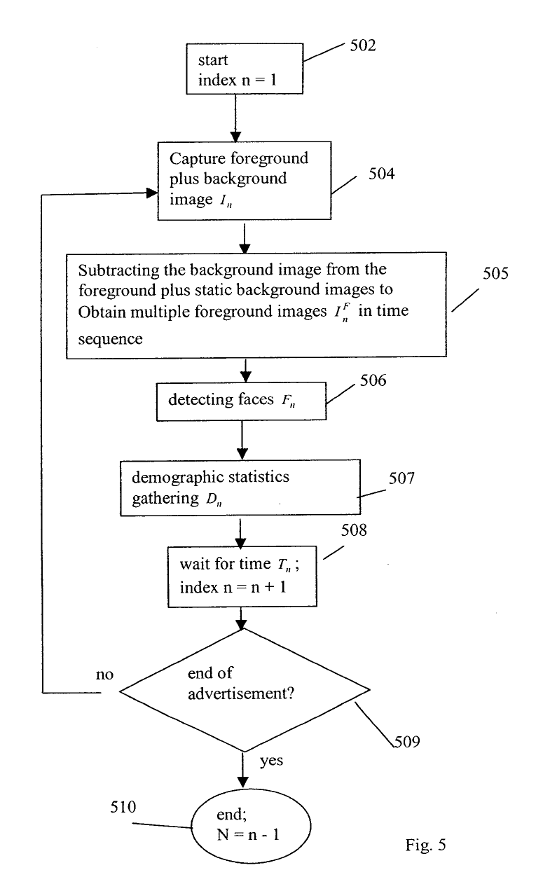

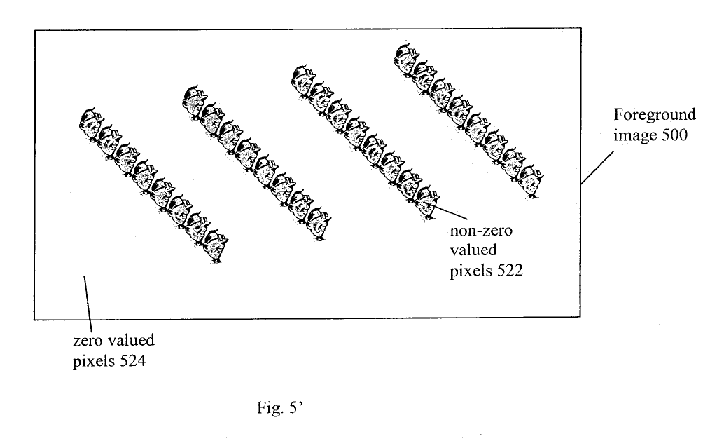

In FIG. 3, the background I^{B} is subtracted from each captured foreground plus background image in step 306. Therefore, a sequence of foreground images is obtained in step 306. An exemplary foreground image 500 is shown in FIG. 5′. In step 306, face detection and demographic analysis are also carried out based on the detected faces.

Referring to FIG. 5, the operation of capturing multiple foreground plus static background images and obtaining a foreground image is shown. In a start step 502, an index n is initialized as 1. Camera 100 in FIG. 4B captures an image, Iᵢ, of the foreground plus static background as the start time in step 504. An exemplary foreground plus static background image 409 is shown in FIG. 4B′. The operation of the infrared camera or a multimodal imaging device 100 is controlled by image processor 102 as shown in FIG. 1.

In step 505, the background image is subtracted from the foreground plus static background images I^{B}_{b}. Therefore, a sequence of foreground images, denoted by Iₙ^{F}, is obtained in step 505. An exemplary foreground image 500 is shown in FIG. 5′. The foreground images contain foreground objects that are non-zero valued pixels 522. Areas in the foreground images other than the foreground object regions are filled with zero valued pixels 524.

The foreground image Iₙ^{F} is used in step 506 to detect faces. In step 507, the detected faces are used to obtain movie viewer demographic statistics.

A program residing in the image processor 102 waits for time T₁ and increases the index n by 1 in step 508. In a query step 509, a status of the theater operation is checked. If it is not the end of playing advertisement, camera 100 takes another foreground plus background image Iₙ in step 504. Then steps 504, 505, 506, 507 and 508 repeat. If it is the end of playing advertisement, the image capturing operation stops in step 510. In step 510, the total number of images, n−1, is recorded in variable N. Thus, the index n for the foreground plus background image Iₙ varies from 1 to N. The index n for the foreground image Iₙ^{F} varies from 1 to N, the same as the foreground plus background image Iₙ.

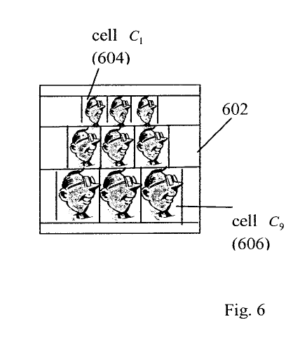

In fact, before the steps 506 and 507 (equivalently, step 306) can be carried out, a step of training and calibration 312 needs to be performed. The input to the step of training and calibration 312 is a calibration foreground image 318 (as shown back in FIG. 3). This calibration foreground image is obtained when the theater is full. An exemplary calibration foreground image 602 is shown in FIG. 6. To do the calibration, the camera 100 is properly oriented such that the foreground image 602 is divided into a plurality of grid cells such as cell C₁ (604), and C₉ (606). Due to the perspective projection distortion, objects far from the camera appears smaller in the image, therefore, cell sizes are different. Note that the theater seats are fixed and the camera 100 can be fixed relatively to the seats, so the cells can be readily defined in the image in the calibration stage. As an example, the foreground image 602 shows 9 viewers sitting on 9 seats. It is understood that if there is an empty seat, the cell corresponding to that seat in the foreground image is filled with zero valued pixels. So, by counting the non-zero valued pixels for a defined cell it can be determined if there is a viewer sitting in a seat corresponding to that cell. A positive decision is made if the number of non-zero valued pixels exceeds a threshold defined for that cell. The parameters of cell size, cell position in the image and non-zero valued pixel count threshold are regarded as calibration statistics 314 (as also shown back in FIG. 3) to be used in step 306 (also steps 506 and 507).

To explain the operation of step 306 and associated operations, the following C-like code is used:

```
    take background image I^{B}
    n = 0;
    while (not end of advertisement)
    {
        n = n + 1;
        take foreground plus static background Iₙ
        subtract I^{B} from Iₙ to get foreground image Iₙ^{F}
        for i = 1 to defined number of cells
      {
          if cell Cₙᵢ has the number of non-zero valued pixels >
threshold
          Cₙᵢ = 1;
    detecting faces and gathering demographic statistics;
      }
      wait Tₙ;
    }
```

In the above code, the operation, Cₙᵢ=1, indicates that there is a viewer sitting at the seat corresponding to cell i in foreground image n.

The operations of background subtraction and calibrating foreground images into cells make the face detection simpler. In step 506 of detecting faces, a face detector does not need to search the entire foreground image, instead, the face detector only operates on a cell if the cell is indicated as a face candidate region with Cₙᵢ=1 in the previous steps. A preferred face detection algorithm can be found in “Method for locating faces in digital color images”, U.S. Pat. No. 7,110,575, by Shoupu Chen et al. This algorithm includes the steps of generating a mean grid pattern element (MGPe) image from a plurality of sample face images; generating an integral image from the digital color image; and locating faces in the color digital image by using the integral image to perform a correlation between the mean grid pattern element (MGPe) image and the digital color image at a plurality of effective resolutions by reducing the digital color image to a grid pattern element images (GPes) at different effective resolutions and correlating the MGPe with the GPes.

People skilled in the art should know that other face detection algorithms can be readily employed to accomplish the task of step 506.

The face detector 506 outputs the locations and sizes of faces found in the image(s). Each face detected is preferably classified as baby, child, adult or senior in step 507. A method for assigning a face to an age category is described in U.S. Pat. No. 5,781,650 by Lobo issued on Jul. 14, 1998. The adult faces are further classified as male or female.

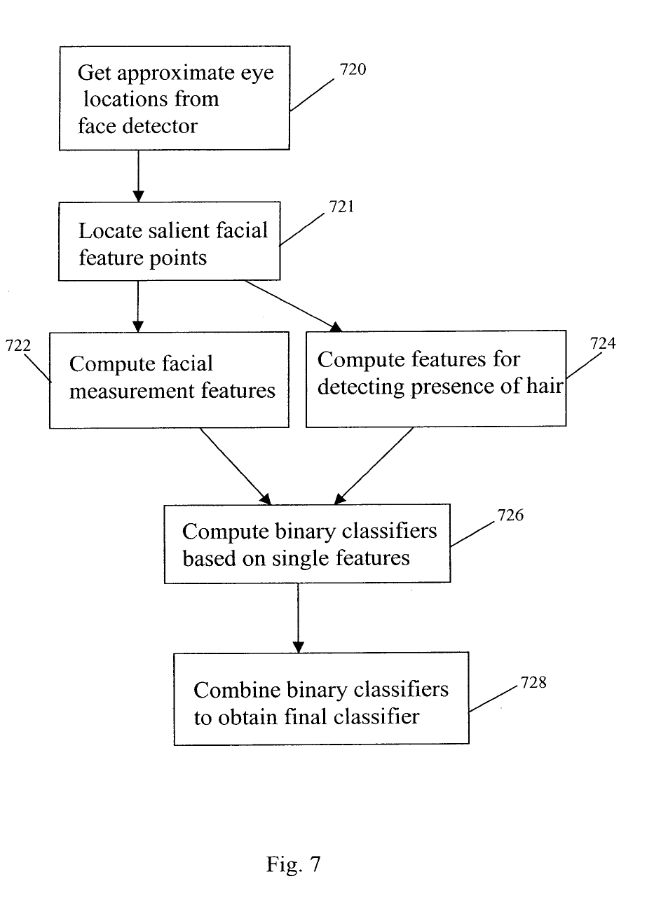

In a preferred embodiment, gender classification involves the steps shown in FIG. 7. In this regard, the approximate eye locations are obtained from the face detector 720 and used to initialize the starting face position for facial feature finding. Eighty two facial feature points are detected 721 using the Active Shape Model-based method described in “An Automatic Facial Feature Finding System for Portrait Images,” by Bolin and Chen in the Proceedings of IS&T PICS conference, 2002.

Some facial measurements that are known to be statistically different between men and women (ref. “Anthropometry of the Head and Face” by Farkas (Ed.), 2^{nd} edition, Raven Press, New York, 1994, and “What's the difference between men and women? Evidence from facial measurement” by Burton, Bruce and Dench, Perception, vol. 22, pp. 153-176, 1993) are computed 722. The features are normalized by the inter-ocular distance, to eliminate the effect of differences in the raw size of the face. For symmetrical features, measurements from the left and right side of the faces are averaged to produce more robust measurements.

The presence or absence of hair in specific location on and around the face are also cues used by humans for gender determination. These features are incorporated 724 as a difference in gray-scale histograms between the patch where hair may be present, and a reference patch on the cheek that is typically hairless.

Binary classifiers are constructed 726 using each of the possible single features separately. Simple Bayesian classifiers described in standard literature (“Pattern Classification” by R. O. Duda, P. E. Hart and D. G. Stork, John Wiley and Sons, 2001) are trained on large sets of example male and female faces to produce the single feature-based binary classifiers. The classification accuracy of each of these binary classifiers ranged from 55 to 75%.

The binary classifiers were combined using the AdaBoost algorithm to produce an improved final classifier 728. AdaBoost is a well-known algorithm for boosting classifier accuracy by combining the outputs of weak classifiers (such as the single feature binary classifiers described above). The weighted sum of outputs of the weak classifiers is compared with a threshold computed automatically from the training examples. A description and application of this method is available in “Rapid Object Detection Using a Boosted Cascade of Simple Features” by P. Viola and M. Jones, in International Conference on Computer Vision and Pattern Recognition, 2001. The classification accuracy of the final classifier obtained using AdaBoost was 90% on un-aligned faces.

Based on the information computed above, each face is assigned a demographic profile, which includes the age and gender of the people.

The invention has been described with reference to one or more embodiments. However, it will be appreciated that variations and modifications can be effected by a person of ordinary skill in the art without departing from the scope of the invention.

### PARTS LIST

100 image source/infrared camera
102 image processor
104 CRT display
106 keyboard
107 computer readable storage medium
108 mouse
109 output device
200 flowchart step
202 flowchart step
204 flowchart step
206 flowchart step
208 flowchart step
210 flowchart step
302 flowchart step
304 flowchart step
306 flowchart step
312 flowchart step
314 flowchart step
316 flowchart step
318 flowchart step
402 static background image
404 theater
406 static background scene
408 static background plus foreground scene
409 foreground plus static background image
500 calibration statistics
502 flowchart step
504 flowchart step
505 flowchart step
506 flowchart step
507 flowchart step
508 flowchart step
509 flowchart step
510 flowchart step
522 demographic data statistics
524 calibration foreground image
602 exemplary calibration foreground image
604 cell
606 cell
720 flowchart step
721 flowchart step
722 flowchart step
724 flowchart step
728 flowchart step

What is claimed is:

1. A method for automatically collecting viewer statistics from one or more persons in a movie theater, comprising the steps of:
a) capturing images of the movie theater and the one or more persons in the movie theater with a camera that captures an image with at least a non-visible portion of a spectrum;
b) using a facial-recognition algorithm to determine one or more persons present in the movie theater; and
c) determining one or more categories from characteristics of persons present in the movie theater to compute the viewer statistics.

2. The method as in claim 1, wherein the camera is an infrared camera.

3. The method as in claim 1 further comprising the step of determining age and/or gender of the one or more persons in the movie theater.

4. A system for automatically collecting viewer statistics from one or more persons in a movie theater, the system comprising:
a) an infrared camera disposed in the movie theater for capturing an image of the one or more persons in the movie theater;
b) a facial-recognition algorithm for determining the presence of persons in the movie theater; and
c) a category algorithm for determining categories from characteristics from persons present in the movie theater to compute the viewer statistics.

5. The system as in claim 4, wherein the facial-recognition algorithm determines age and/or gender of the one or more persons in the movie theater.

6. A method for automatically collecting viewer statistics from one or more persons in a movie theater, comprising the steps of:
a) capturing composite digital images of the movie theater and the one or more persons in the movie theater with a multimodal imaging device;
b) using a facial-recognition algorithm to determine one or more persons present in the movie theater; and
c) determining one or more categories from characteristics of persons present in the movie theater to compute the viewer statistics.
